(19) United States
(12) Patent Application Publication
(10) Pub. No.: US 2015/0339456 A1
(43) Pub. Date: Nov. 26, 2015

(54) METHOD AND APPARATUS FOR DETECTING CONTROLLED SUBSTANCE ABUSE OR DIVERSION

(71) Applicant: iLumHealth, LLC, The Woodlands, TX (US)

(72) Inventor: Michael Sprintz, Houston, TX (US)

(21) Appl. No.: 14/391,341

(22) PCT Filed: Feb. 14, 2014
(86) PCT No.: PCT/US14/16480

§ 371 Date: Oct. 8, 2014

Related U.S. Application Data
(60) Provisional application No. 61/765,704, filed on Feb. 16, 2013.
(60) Provisional application No. 61/841,280, filed on Jun. 29, 2013.

(51) Int. Cl. G06F 19/00

(52) U.S. Cl. CPC G06F 19/3431

(57) ABSTRACT

A method and apparatus (including software) for predicting abuse or diversion of one or more controlled substances comprising identifying a potential abuser or diverter, accessing one or more databases containing potential abuser or diverter data, comparing potential abuser or diverter data with data of indicators of abuse or diversion, and assigning abuse or diversion likelihood score to the potential abuser or diverter. The abuse or diversion likelihood score then usable in the process of making decisions regarding the potential abuser or diverter.

### FIELD OF INVENTION

The current invention relates to a software program for, and methods of, detecting potential controlled substance abuse, misuse, or diversion, and an apparatus for doing the same.

### BACKGROUND OF THE INVENTION

The prescription drug abuse epidemic continues to surge in both its reach and its devastation, while the cost to federal, state, and local governments is staggering. For example, in 2005 federal, state, and local government spending as a result of substance abuse and addiction was at least $467.8 billion: $238.2 billion, federal; $135.8 billion, state; and $93.8 billion, local. Total government spending of $467.8 billion on substance abuse and addiction amounted to 10.7 percent of their entire $4.4 trillion budgets.

In that same year, for every taxpayer dollar spent on substance abuse, 95.6 cents went to treating the consequences, while only 1.9 cents was spent on prevention and treatment, 0.4 cents was spent on research, 1.4 cents was spent on taxation or regulation, and 0.7 cents was spent on interdiction.

The wreckage extends far beyond the State's coffers and insurer's bottom lines. Overdose deaths from prescription drugs are now the number one cause of accidental death in this country. With 80-90% of the prison population with an alcohol or drug problem or related crime, untreated drug and alcohol abuse drives crime, fatalities, victimization, auto accidents, and an ever-expanding financial drain on our criminal justice and healthcare systems. The number of babies born with neonatal abstinence syndrome continues to increase, along with the astronomical costs of caring for these newborns, often severely premature and the life-long medical complications that result from being born premature and addicted. Meanwhile, the precious and limited resources are being spent reactively on the consequences of substance abuse rather than the economically-sound model of using such resources for the prevention, treatment, and long-term management of drug and alcohol abuse.

Spending of addiction treatment was estimated at $28 billion in 2010, with public payers contributing 79.2% of the bill. State and local governments spent $229 billion dollars on the consequences of addiction and only $12.6 billion on treatment of the disease.

State-funded programs such as Medicaid and the criminal justice system are hemorrhaging money trying to handle the consequences of their covered populations' substance abuse problem without a reasonable, effective strategy to address the current problem, nor any plan to prevent more of the same.

As State budgets tighten in this challenging economic environment, funding for addiction treatment and preventive services will continue to get cut, worsening the problem and causing a vicious downward spiral of economic and social consequences.

The role of state prescription drug monitoring programs (PDMPs) in facilitating appropriate prescribing of controlled prescription drugs and helping to address the prescription drug abuse or diversion epidemic has been highlighted in recent studies and in the 2011 White House Office of National Drug Control Policy's Prescription Drug Abuse Prevention Plan (GAO, 2002; Pradel et al., 2009; Baehren et al., 2010; Katz et al., 2010; Johnson et al., 2011; Office of National Drug Control Policy, 2011).

A PDMP is a statewide electronic database that gathers information from pharmacies on dispensed prescriptions for controlled substances (most states that permit practitioners to dispense also require them to submit prescription information to the PDMP). Many PDMPs now provide secure online access to this information for authorized recipients. Prescription data (usually for the past year, and including information on date dispensed, patient, prescriber, pharmacy, medicine, and dose) is made available on request from end users, typically prescribers and pharmacists, and sometimes is distributed via unsolicited reports. Recipients of PDMP data may also include practitioner licensure boards, law enforcement and drug control agencies, medical examiners, drug courts and criminal diversion programs, addiction treatment programs, public and private third-party payers, and other public health and safety agencies. States vary widely in which categories of users are permitted to request and receive prescription history reports and under what conditions.

While PDMPs contain useful information, several impediments may hinder prescribers and dispensers from accessing or using this information. There are multiple problems with current State PDMP programs that result in their lack of use. For example, many PDMPs do not actively monitor and notify, their data is not current or in real time, and they lack a process of making automated queries. These issues, among others, are addressed by the current invention.

### SUMMARY OF THE INVENTION

In one exemplary embodiment, the present invention is a method of predicting abuse or diversion of one or more controlled substances. The method involves identifying a patient, accessing one or more databases containing patient data, comparing patient data with data of indicators of abuse or diversion, and assigning an abuse or diversion likelihood score to the patient.

In another exemplary embodiment, the present invention is a computer readable medium comprising computer executable instructions recorded thereon for predicting abuse or diversion of one or more controlled substances. The predicting method involves identifying a patient, accessing one or more databases containing patient data, comparing patient data with data of indicators, and assigning an abuse or diversion likelihood score to the patient.

In another exemplary embodiment, the present invention is a method of predicting abuse or diversion of one or more controlled substances. The method involves identifying a prescriber, accessing one or more databases containing prescriber data, comparing prescriber data with data of indicators of abuse or diversion, and assigning abuse or diversion likelihood score to the prescriber.

In another exemplary embodiment, the present invention is a computer readable medium comprising computer executable instructions recorded thereon for predicting abuse or diversion of one or more controlled substances. The method involves identifying a prescriber, accessing one or more databases containing prescriber data, comparing prescriber data with data of indicators, and assigning abuse or diversion likelihood score to the prescriber.

In another exemplary embodiment, the present invention is a method of predicting abuse or diversion of one or more controlled substances. The method involves identifying a dispenser, accessing one or more databases containing dispenser data, comparing dispenser data with data of indicators of abuse or diversion, and assigning an abuse or diversion likelihood score to the dispenser.

In another exemplary embodiment, the present invention is a computer readable medium comprising computer executable instructions recorded thereon for predicting abuse or diversion of one or more controlled substances. The method involves identifying a dispenser, accessing one or more databases containing dispenser data, comparing dispenser data with data of indicators, and assigning an abuse or diversion likelihood score to the dispenser.

In another exemplary embodiment, the present invention is an apparatus for predicting abuse or diversion of one or more controlled substances. The apparatus includes hardware for receiving the identity of a patient, prescriber, or dispenser; accessing one or more databases containing patient, prescriber, or dispenser data; comparing the patient, prescriber, or dispenser data with data of indicators; and, assigning an abuse or diversion likelihood score to the patient, prescriber, or dispenser.

The embodiments mentioned are exemplary only and are not meant to limit the invention, as is more fully described and claimed below.

### DESCRIPTION OF THE FIGURES

FIG. 1 shows an exemplary screenshot of a physician's desktop. Scores associated with a specific set of patients are displayed.

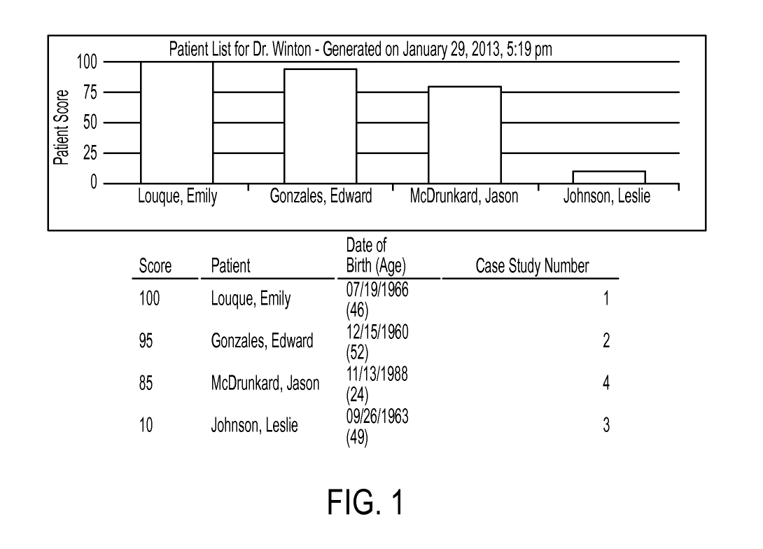

FIG. 2 is a timeline display of a patient's score; the graph indicates a pattern of compliance after corrective action taken when the score had peaked.

FIG. 3 is a display of locations on a map; this figure shows the patient's location on the right corner of the figure, the physician's location at the bottom of the figure, and the pharmacy location at the upper left corner.

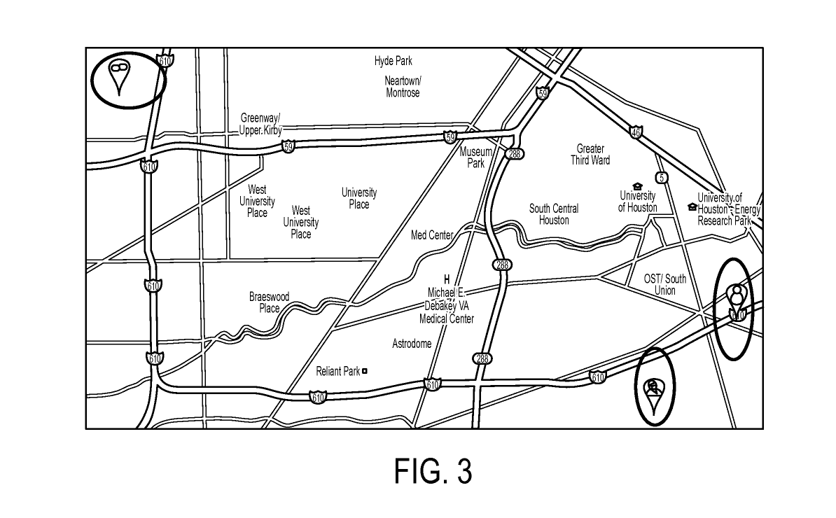

### DETAILED DESCRIPTION OF THE INVENTION

### Definitions

Unless defined otherwise, all technical and scientific terms used herein have the same meaning as commonly understood by one of ordinary skill in the art.

The term “controlled substance”, as used herein, without limitation, is with reference to drugs, prodrugs, precursors, or substances, the prescription and administration of which is regulated. This definition also includes alcohol, tobacco products, nicotine delivery systems, pseudoephedrine, and the like, which do not require a prescription, but are either regulated or have relevance to detection of abuse or diversion.

The term “potential abuser or diverter”, as used herein, without limitation, may be any person, institution, or a business that may interact with a controlled substance. In one instance the potential abuser or diverter is a patient, in another instance the potential abuser or diverter is a prescriber, and in yet another instance the potential abuser or diverter is a dispenser. In some instances the potential abuser or diverter is an institution, and in another instance the potential abuser or diverter is a legal business, and it yet another instance the potential abuser or diverter is an illegal business.

The term “data of indicators”, as used herein, without limitation, means one or more features or groups of features, which can be (or can be used as) predictors of abuse or diversion.

The term “abuse or diversion likelihood score”, as used herein, without limitation, can be a numerical value assigned to a potential abuser or diverter. This numerical value may further be color coded; for example: a high value may be coded with red.

The term “patient”, as used herein, without limitation, includes any person who may seek, or is given, a controlled substance for self or for others. Others may be humans or non-humans.

The term “prescriber”, as used herein, without limitation, includes any individual or entity prescribing controlled substances.

The term “dispenser”, as used herein, without limitation, includes any individual or entity that fills a prescription or dispenses a medication or controlled substance, including for example, sample medications dispensed in a medical office setting.

The term “user”, as used herein, without limitation, may be any individual or entity. In some cases, the methods disclosed in this application may also be used (or interfaced) with other software. In such cases the “user” is a program or software.

The term “computer readable medium”, without limitation, includes any medium that can store or transfer information, including volatile, nonvolatile, removable and non-removable media.

The term “processor” refers, without limitation, generally to any programmable system including systems and microcontrollers, reduced instruction set circuits (RISC), application specific integrated circuits (ASIC), programmable logic circuits (PLC), and any other circuit or processor capable of executing functions or programs.

The term “pull notification” refers to the mode of interaction wherein the user requests the information.

The term “push notification” refers to the mode of interaction wherein the user is mostly passive; the decision to provide information is made without the user making continuous requests.

Some terms used herein are also defined in Title 21 Code of Federal Regulations (C.F.R.) §1300.1, which is incorporated herein by reference.

### EXEMPLARY EMBODIMENTS OF THE INVENTION

### Method of Predicting: Abuse or Diversion by a Patient

In one embodiment, the present invention is a method of predicting abuse or diversion of one or more controlled substances. The method involves identifying a patient, accessing one or more databases containing patient data, comparing patient data with data of indicators of abuse or diversion, and assigning an abuse or diversion likelihood score to the patient.

The patient may be identified by a user of this method, where the user is any individual or a program (which may be run by a person or scheduled to run automatically).

In one aspect, the databases containing patient data, without limitation, incorporate data provided by a regulatory authority. The regulatory authority, without limitation, in one instance is a drug testing authority (government or non-government), a law enforcement authority, a legal system, a healthcare licensing or healthcare credentialing authority, a state medical board, a state pharmacy board, a state nursing board, a state veterinary board, a state chiropractic board, a state dental board, a state podiatry boards, a department of transportation, a state bar, or the like.

In another aspect, the databases containing patient data incorporate data provided, without limitation, by a prescription or a prescriber. The prescriber, without limitation, can be a doctor, a physician assistant, a nurse practitioner, a dentist, a veterinarian, a podiatrist, a chiropractor, any individual or entity legally authorized to prescribe controlled substances, or any individual or entity ill-legally prescribing a controlled substance.

In another aspect, the databases containing patient data incorporate data provided, without limitation, by a dispenser. The dispenser, without limitation, can be a pharmacy, a pharmacist, a physician or a physician's authorized agent, such as a nurse practitioner or physician assistant dispensing under the license of the physician.

In another aspect, the databases containing patient data incorporate data provided, without limitation, by a supplier. The supplier, without limitation, can be a brand name supplier, a generic supplier, a pharmacy warehouse, a wholesaler, or a distributer.

In another aspect, the databases containing patient data incorporate data provided, without limitation, by a compounder, an importer, an exporter, a manufacturer, a toxicology report, a drug-testing or a clinical laboratory, or a healthcare provider.

In another aspect, the databases containing patient data incorporate data provided, without limitation, by an insurance provider or third-party payer, a government agency, a credit bureau, a research organization, a pharmacy or healthcare benefits manager, a Health Information Exchange (HIE), an electronic medical record (EMR) or electronic healthcare record (HER), a pharmacy benefits manager, a financial institution, a communications company, an internet or web-based services provider (hosting, data tracking, search engines, a mobile device content or advertisement provider), a GPS or other location-tracking provider, a face-recognition or other bio-identification company, a surveillance company, a security company, or a data analytics company.

In another aspect, the databases containing patient data incorporate data provided, without limitation, by user input.

In a further aspect, the data of indicators may include, without limitation, data relating to a controlled substance. The controlled substance, without limitation, may be any substance as defined by the Drug Enforcement Administration (DEA) in Title 21 Code of Federal Regulations (C.F.R.) §§1308.11 through 1308.15. The lists of Schedule I-V controlled substances are herein incorporated by reference. Any other drug, alcohol, and beverages thereof that can be abused or diverted are also considered as controlled substances.

In general Schedule I-Schedule V drugs are assigned priority—high to low, in the same order, for the purpose of assigning an abuse or diversion likelihood score. The following drugs are also given higher priority for the purpose of assigning abuse or diversion likelihood score: opiates/opioids such as hydrocodone, oxycodone, morphine, fentanyl, buprenorphine, suboxone (buprenorphine/naloxone), codeine, hydromorphone and methadone; muscle relaxants such as carisoprodol (soma) and cyclobenzaprine; CNS depressants such as alprazolam, lorazepam, clonazepam, diazepam, phenobarbital, nembutal and amobarbital; CNS stimulants such as amphetamine, methylphenidate, phentermine, modafanil (provigil) and armodafanil (nuvigil); and anabolic steroids. This list is not all-inclusive and may cover all controlled substances currently regulated by the U.S. Controlled substances Act, as well as new compounds that may have any abuse or diversion or diversion potential.

In another aspect, the data of indicators may include, without limitation, data relating to a diagnosis of substance abuse or diversion, substance dependence, process addictions, such as food addiction, gambling addiction, internet addiction, pornography addiction, sex addiction, video game addiction, exercise addiction; unipolar disorder, bipolar disorder, post-traumatic stress disorder (PTSD), anorexia, bulimia, schizophrenia, mood disorder, personality disorders, sociopathy, psychopathy, ADHD or ADD, cancer, and terminal cancer.

In another aspect, the data of indicators may include, without limitation, data corresponding to a behavior, such as possessing drugs for addiction or precursors thereof, substance abuse or diversion, misuse, dependence, diversion of controlled substances, and smoking.

In another aspect, the data of indicators may include, without limitation, data relating to a CPT (Current Procedural Terminology) code, an International Classification of Diseases code (ICD-9, ICD-10, and all future versions of diagnosis codes), evaluation and management (E&M) codes, a procedure, a disciplinary action, a legal judgment, a laboratory test or result, a disorder, a condition or a syndrome, a bio-identification marker, an image, a document, suppliers, importers, exporters, manufacturers, or compounders.

In another aspect, the data of indicators may include, without limitation, data corresponding to a record, which includes a history of positive drug test, a drug related criminal record, a non-drug related criminal record, a DUI conviction, a multiple DUI conviction, a family history of substance abuse or diversion, police reports related to stolen or missing prescriptions or controlled substances, or a history of non-drug related abuse or diversion (abusing or being abused).

In another aspect, the data of indicators may include, without limitation, data corresponding to a timeline, such as frequency of emergency room visits, high number of prescribers in a short period, high number of doses during a short period, more than one payment within a short period, frequency and length of overlapping prescriptions, frequency of unhealthy combinations of controlled substances, frequency of an out of state prescriber, more than one method of payment in a short time, more than of one pharmacy on the same day, more than one pharmacy in different health districts in one month, frequency of multiple controlled substance prescriptions from more than one prescriber, frequency of multiple controlled substance prescriptions from one prescriber, frequency of opioid prescriptions, or frequency of multiple, early refills and combinations thereof.

In another aspect, the data of indicators may include, without limitation, data corresponding to a prescription, which includes the number of prescriptions for opioids, prescription for controlled substance without an ICD code for a diagnosis warranting such a prescription, and total number of prescriptions.

In another aspect, the data of indicators may include, without limitation, data corresponding to prescribers, which includes number of prescribers, prescribers with a incidence of high controlled substance prescription, prescribers with unusual prescribing patterns, prescribers self-prescribing controlled substances, percentage of controlled prescriptions prescribed, prescribers with history of medical disciplinary action (prescription, alcohol, and drug related), prescribers exceeding a set threshold of controlled substance prescription, number of patients with alerts visiting a prescriber, location of the prescriber, and percentage of patients paying the prescriber with cash.

In another aspect, the data of indicators may include, without limitation, data corresponding to a dispenser, which includes the number of pharmacies visited by the patient, percent or cash payments, percent of controlled substances dispensed, number of controlled substances filled, number of patients with alerts, location, ratio inventory of controlled substances vs. uncontrolled prescription dispensed, and number of controlled substances ordered by the dispensers.

In a further aspect of the invention, a high abuse or diversion likelihood score, indicating high probability of abuse or diversion, is assigned when the patient data and the data of indicators overlap and where the overlap is high. A low abuse or diversion likelihood score, indicating low probability of abuse or diversion, is assigned when the patient data and the data of indicators overlap and where the overlap is low.

The overlap and the determination of whether the overlap is high or low can be computed by a summation of weighted matches between the patient data and the data of indicators. For example, in a simple instance, a weight assigned to a Schedule-I drug (e.g. heroin) is high, and the patient with such an overlap/match is assigned a high score. The weight of indicators may change as research evidence further supports or refutes an indicator as it relates to the likelihood of abuse or diversion.

In a more involved case, the weights may be variable, for example, where two patients A and B use the same controlled substance but patient B has had a prior drug related conviction. In such a case, the weight for a match for patient A will be low, whereas for patient B will be high. In addition, patient B's abuse or diversion likelihood score will include an additional component for the prior conviction.

In some cases the weight may be negative. This would be in a case, for example, where a patient has cancer and is using pain medication. The amount of pain medication and its frequency used by the cancer patient may contribute to a high abuse or diversion likelihood score. However, a diagnosis of late stage cancer would contribute a sufficiently large negative weight so as to override an otherwise high abuse or diversion likelihood score.

In some instances an authorized user of the method may permanently set the abuse or diversion likelihood score high or low as needed.

In a further aspect of the invention, the abuse or diversion likelihood score is used for decision making by prescribers, dispensers, law enforcement, government agencies, research organizations, regulatory or licensing agencies, insurance agencies, parole boards, or by predictive modeling software.

### Software for Prediction: Abuse or Diversion by a Patient

In another embodiment, the invention is a computer readable medium comprising computer executable instructions recorded thereon for performing the method of predicting abuse or diversion of one or more controlled substances. The method involves identifying a patient, accessing one or more databases containing patient data, comparing patient data with data of indicators of abuse or diversion, and assigning abuse or diversion likelihood score to the patient. The patient may be identified by a user of the program.

The term “computer-readable medium”, without limitation, includes any medium that can store or transfer information, including volatile, nonvolatile, removable and non-removable memory or media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk, or any other medium which can be used to store the desired information and which can be accessed. A computer data signal includes any signal that can propagate over a transmission medium such as electronic network channels, optical fibers, air, electromagnetic, RF links, etc. Code segments may be downloaded via computer networks such as the Internet or an intranet. In any case, the scope of the present disclosure should not be construed as limited by such embodiments.

Computer-executable instructions comprise, without limitation, instructions and data which, when executed, cause a computer or a processing device to perform a certain function or a group of functions. The computer executable instructions may be, for example, shell-script, binaries, intermediate format instructions such as assembly language, or source code or object code.

Aspects of the invention relating to controlled substances, databases containing patient data, data of indicators, and assignment of abuse or diversion likelihood scores are as described in the above section.

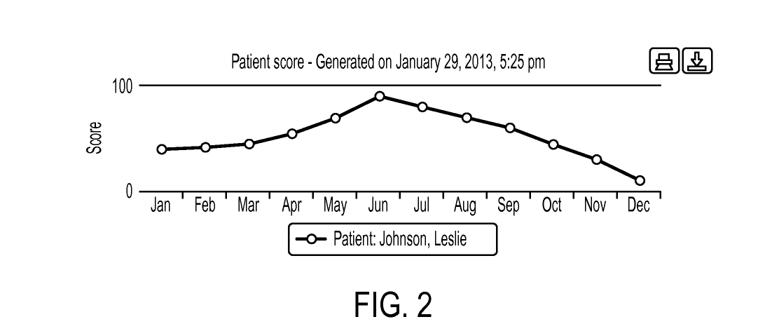

In a further aspect of the invention, the abuse or diversion likelihood score is computed, without limitation, at fixed intervals. A plot of the variation of the score with time and inflections therein can be presented such as that shown in FIG. 2.

In another aspect of the invention, the abuse or diversion likelihood score is computed, without limitation, before the patient's visit, after the patient's visit, or during the patient's visit to the prescriber or to the dispenser. This enables the prescriber or the dispenser to actively track the patient's compliance.

In yet another aspect of the invention, the abuse or diversion likelihood score is displayed, without limitation, in a format of user's choice. For example, the abuse or diversion likelihood score can be in the numerical range: 0-100. The score also may be coded by a color; for example: red is be used to indicate high alert, green indicates a very low score, and shades of yellow, amber and orange may be used for the scores in between.

In yet another aspect of the invention, a display of location information is presented. For example, location information, without limitation, can be presented on a map. In this example, a location on the map is highlighted in a color different from the background color, and the shade of the highlight turns darker with the number of visits. As another example, the size of the highlight turns larger with the number of visits. As yet another example, the highlight may be color coded to indicate the level of abuse or diversion likelihood score contribution (to a specific patient and in general) from the location; for example, a location prescribing or dispensing a large quantity of opiates is coded with a red highlight.

In another aspect of the invention, a display of the timeline of visits to the prescriber or timeline of prescriptions is presented. For example, the display, without limitation, can be grouped by the location of visit. In yet another example, without limitation, the display is grouped by the type of controlled substance prescribed.

In another aspect of the invention, the above-mentioned display, without limitation, is presented via a pull notification. For example, a pharmacist clicks on a few web links and determines the patient's abuse or diversion likelihood score.

In another aspect of the invention, the display, without limitation, is presented via push notification. For example, a doctor receives an email on a mobile device, which alerts her to the high abuse or diversion likelihood score of a scheduled patient.

In one embodiment, the software of this invention is integrated with other software, such other software, without limitation, includes a Health Information Exchange (HIE) program, an electronic medical record (EMR) program, or an electronic healthcare record (HER) program.

In another embodiment, the software of this invention is interfaced with other software, which can be achieved via an application programming interface (API).

### Method of Predicting: Abuse or Diversion by a Prescriber

In one embodiment, the present invention is a method of predicting abuse or diversion of one or more controlled substances. The method involves identifying a prescriber, accessing one or more databases containing prescriber data, comparing prescriber data with data of indicators of abuse or diversion, and assigning an abuse or diversion likelihood score to the prescriber.

The prescriber may be identified by a user of this method, where the user is any individual or a program (which may be run by a person or scheduled to run automatically).

In one aspect, the databases containing prescriber data, without limitation, incorporate data provided by a regulatory authority. The regulatory authority, without limitation, in one instance is a drug testing authority (government or non-government), a law enforcement authority, a legal system, a healthcare licensing or healthcare credentialing authority, a state medical board, a state pharmacy board, a state nursing board, a state veterinary board, a state chiropractic board, a state dental board, a state podiatry boards, a department of transportation, a state bar, or the like.

In another aspect, the databases containing prescriber data incorporate data provided, without limitation, by a prescription or a prescriber. The prescriber, without limitation, can be a doctor, a physician assistant, a nurse practitioner, a dentist, a veterinarian, a podiatrist, a chiropractor, any individual or entity legally authorized to prescribe controlled substances, or any individual or entity ill-legally prescribing a controlled substance.

In another aspect, the databases containing prescriber data incorporate data provided, without limitation, by a dispenser. The dispenser, without limitation, can be a pharmacy, a pharmacist, a physician or a physician's authorized agent, such as a nurse practitioner or physician assistant dispensing under the license of the physician.

In an aspect, the databases containing prescriber data incorporate data provided, without limitation, by a supplier. The supplier, without limitation, can be a brand name supplier, a generic supplier, a pharmacy warehouse, a wholesaler, or a distributer.

In another aspect, the databases containing prescriber data incorporate data provided, without limitation, by a compounder, an importer, an exporter, a manufacturer, a toxicology report, a drug-testing or a clinical laboratory, or a healthcare provider.

In one aspect, the databases containing prescriber data incorporate data provided, without limitation, by an insurance provider or third-party payer, a government agency, a credit bureau, a research organization, a pharmacy or healthcare benefits manager, a Health Information Exchange (HIE), an electronic medical record (EMR) or electronic healthcare record (HER), a pharmacy benefits manager, a financial institution, a communications company, an internet or web-based services provider (hosting, data tracking, search engines, a mobile device content or advertisement provider), a GPS or other location-tracking provider, a face-recognition or other bio-identification company, a surveillance company, a security company, or a data analytics company.

In another aspect the databases containing prescriber data incorporate data provided, without limitation, by user input.

In a further aspect, the data of indicators may include, without limitation, data relating to a controlled substance. The controlled substance, without limitation, may be any substance as defined by the Drug Enforcement Administration (DEA) in Title 21 Code of Federal Regulations (C.F.R.) §§1308.11 through 1308.15. The lists of Schedule I-V controlled substances are herein incorporated by reference. Any other drug, alcohol, and beverages thereof that can be abused or diverted are also considered as controlled substances.

In general Schedule I-Schedule V drugs are assigned priority—high to low, in the same order, for the purpose of assigning an abuse or diversion likelihood score. The following drugs are also given higher priority for the purpose of assigning abuse or diversion likelihood score: opiates/opioids such as hydrocodone, oxycodone, morphine, fentanyl, buprenorphine, suboxone (buprenorphine/naloxone), codeine, hydromorphone and methadone; muscle relaxants such as carisoprodol (soma) and cyclobenzaprine; CNS depressants such as alprazolam, lorazepam, clonazepam, diazepam, phenobarbital, nembutal and amobarbital; CNS stimulants such as amphetamine, methylphenidate, phentermine, modafanil (provigil) and armodafanil (nuvigil); and anabolic steroids. This list is not all-inclusive and may cover all controlled substances currently regulated by the U.S. Controlled substances Act, as well as new compounds that may have any abuse or diversion or diversion potential.

The number of prescriptions written, multiple prescriptions to a single patient, multiple classes of controlled substances to a single patient, self-prescription, percent of controlled substance prescribed, and exceeding a set threshold in given time can be all included, without limitation, in the data of indicators.

In another aspect, the data of indicators, without limitation, includes data of a regulatory authority. Such data is acquired, without limitation, from law enforcement authorities, judicial authorities, medical boards (disciplinary actions: prescription, drug or alcohol related) and PDMP (Prescription Drug Monitoring Programs) maintaining authorities.

In yet another aspect, the data of indicators, without limitation, includes data relating to a location, including information concerning where the prescriptions are filled and patients' addresses.

In another aspect, the data of indicators, without limitation, includes data relating to the type of patients, including the number of patients with alerts (indicated by the current method or by any other means), the number of patients with history of controlled substance abuse or diversion, and/or the number of patients paying with cash.

In a further aspect of the invention, a high abuse or diversion likelihood score, indicating high probability of abuse or diversion, is assigned when the prescriber data and the data of indicators overlap and where the overlap is high. A low abuse or diversion likelihood score, indicating low probability of abuse or diversion, is assigned when the prescriber data and the data of indicators overlap and where the overlap is low.

The overlap and the determination of whether the overlap is high or low can be computed by a summation of weighted matches between the prescriber data and the data of indicators. For example, a prescriber who self-prescribes a controlled substance will be given high abuse or diversion likelihood score. The score will be higher if there is another match, for example, a number of the prescriber's patients have prescriptions for opiates.

In some instances an authorized user of the method may permanently set the abuse or diversion likelihood score high or low as needed.

In a further aspect of the invention the abuse or diversion likelihood score is used, without limitation, for decision making by dispensers, law enforcement, government agencies, research organizations, regulatory or licensing agencies, insurance agencies, parole boards, or by predictive modeling software.

### Software for Prediction: Abuse or Diversion by a Prescriber

In another embodiment, the invention is a computer readable medium comprising computer executable instructions recorded thereon for performing the method of predicting abuse or diversion of one or more controlled substances. The method involves identifying a prescriber, accessing one or more databases containing prescriber data, comparing prescriber data with data of indicators of abuse or diversion, and assigning abuse or diversion likelihood score to the prescriber.

The prescriber may be identified by a user of this method, where the user is any individual or a program (which may be run by a person or scheduled to run automatically).

The terms “computer-readable medium” and “computer executable instructions” are as described in the preceding sections. Aspects of the invention relating to controlled substances, databases containing prescriber data, data of indicators, and assignment of abuse or diversion likelihood scores are as described in the above section.

In a further aspect of the invention, the abuse or diversion likelihood score is computed, without limitation, at fixed intervals and before disciplinary board meetings. A plot of the variation of the score with time and inflections therein can be presented.

In another aspect of the invention the abuse or diversion likelihood score is computed, without limitation, before the prescriber's visit, after the prescriber's visit, or during the prescriber's visit to the dispenser. This enables the dispenser to actively track the prescriber's score and query the need for a selected prescription.

In yet another aspect of the invention, the abuse or diversion likelihood score is displayed, without limitation, in a format of user's choice. For example, the abuse or diversion likelihood score can be in the numerical range: 0-100. The score also may be coded by a color code; for example: red is used to indicate high alert, green may indicate a very low score, and shades of yellow, amber and orange may be used for the scores in between.

In yet another aspect of the invention, a display of location information is presented. For example, location information, without limitation, can be presented on a map. In this example, a location on the map is highlighted in a color different from the background color, and the shade of the highlight turns darker with the number of visits. As another example, the size of the highlight turns larger with the number of visits. As yet another example, the highlight may be color coded to indicate the level of abuse or diversion likelihood score contribution (to a specific patient or prescriber and in general) from the location; for example, a location prescribing or dispensing a large quantity of opiates is coded with a red highlight.

In another aspect of the invention, a display of the timeline of prescriptions is presented. For example, the display, without limitation, is grouped by the frequency of prescriptions. In another example, the display, without limitation, is grouped by the type of controlled substance prescribed.

In another aspect of the invention, the timeline of disciplinary actions against the prescriber can be presented, where recent actions are highlighted.

In another aspect of the invention, the above-mentioned display, without limitation, is presented via a pull notification. For example, a pharmacist clicks on a few web links and determines a prescriber's abuse or diversion likelihood score.

In another aspect of the invention, the display, without limitation, is presented via push notification. For example, an authorized person at the state medical board receives an email that alerts her to the high abuse or diversion likelihood score of a certain physician.

In one embodiment, the software of this invention is integrated with other software, such other software, without limitation, includes a Health Information Exchange (HIE) program, an electronic medical record (EMR) program or an electronic healthcare record (HER) program.

In another embodiment, the software of this invention is interfaced with other software, which can be achieved via an application programming interface (API).

### Method of Predicting: Abuse or Diversion by a Dispenser

In one embodiment, the present invention is a method of predicting abuse or diversion of one or more controlled substances. The method involves identifying a dispenser, accessing one or more databases containing dispenser data, comparing dispenser data with data of indicators of abuse or diversion, and assigning an abuse or diversion likelihood score to the dispenser.

In one aspect, the databases containing dispenser data, without limitation, incorporate data provided by a regulatory authority. The regulatory authority, without limitation, in one instance is a drug testing authority (government or non-government), a law enforcement authority, a legal system, a healthcare licensing or healthcare credentialing authority, a state medical board, a state pharmacy board, a state nursing board, a state veterinary board, a state chiropractic board, a state dental board, a state podiatry boards, a department of transportation, a state bar, or the like.

In another aspect, the databases containing dispenser incorporate data provided, without limitation, by a prescription or a prescriber. The prescriber, without limitation, can be a doctor, a physician assistant, a nurse practitioner, a dentist, a veterinarian, a podiatrist, a chiropractor, any individual or entity legally authorized to prescribe controlled substances, or any individual or entity ill-legally prescribing a controlled substance.

In another aspect, the databases containing dispenser data incorporate data provided, without limitation, by a dispenser. The dispenser, without limitation, can be a pharmacy or a pharmacist.

In another aspect, the databases containing dispenser data incorporate data provided, without limitation, by a supplier. The supplier, without limitation, can be a brand name supplier, a generic supplier, a pharmacy warehouse, a wholesaler, or a distributer.

In another aspect, the databases containing dispenser data incorporate data provided, without limitation, by a compounder, an importer, an exporter, a manufacturer, a toxicology report, a drug-testing or a clinical laboratory, or a healthcare provider.

In another aspect, the databases containing dispenser data incorporate data provided, without limitation, by an insurance provider or third-party payer, a government agency, a credit bureau, a research organization, a pharmacy or healthcare benefits manager, a Health Information Exchange (HIE), an electronic medical record (EMR) or electronic healthcare record (HER), a pharmacy benefits manager, a financial institution, a communications company, an internet or web-based services provider (hosting, data tracking, search engines, a mobile device content or advertisement provider), a GPS or other location-tracking provider, a face-recognition or other bio-identification company, a surveillance company, a security company, or a data analytics company.

In another aspect, the databases containing dispenser data incorporate data provided, without limitation, by user input.

In a further aspect, the data of indicators may include, without limitation, data relating to a controlled substance. The controlled substance, without limitation, may be any substance as defined by the Drug Enforcement Administration (DEA) in Title 21 Code of Federal Regulations (C.F.R.) §§1308.11 through 1308.15. The lists of

Schedule I-V controlled substances are herein incorporated by reference. Any other drug, alcohol, and beverages thereof that can be abused or diverted are also considered as controlled substances.

In general Schedule I-Schedule V drugs are assigned priority—high to low, in the same order, for the purpose of assigning an abuse or diversion likelihood score. The following drugs are also given higher priority for the purpose of assigning abuse or diversion likelihood score: opiates/opioids such as hydrocodone, oxycodone, morphine, fentanyl, buprenorphine, suboxone (buprenorphine/naloxone), codeine, hydromorphone and methadone; muscle relaxants such as carisoprodol (soma) and cyclobenzaprine; CNS depressants such as alprazolam, lorazepam, clonazepam, diazepam, phenobarbital, nembutal and amobarbital; CNS stimulants such as amphetamine, methylphenidate, phentermine, modafanil (provigil) and armodafanil (nuvigil); and anabolic steroids. This list is not all-inclusive and may cover all controlled substances currently regulated by the U.S. Controlled substances Act, as well as new compounds that may have any abuse or diversion or diversion potential.

In another aspect, the data of indicators may include, without limitation, data of a regulatory authority, where such data is acquired from law enforcement authorities, judicial authorities, medical boards (disciplinary actions: prescription, drug, or alcohol related) or PDMP (Prescription Drug Monitoring Programs) maintaining authorities.

In another aspect, the data of indicators may include, without limitation, data relating to a location, such as location information with regards to where the prescriptions are prescribed and addresses of patients.

In another aspect, the data of indicators may include, without limitation, data relating to the type of patients, the number of patients with alerts (indicated by the methods of the present invention or by any other means), the number of patients with history of controlled substance abuse or diversion, or the number of patients paying with cash vs. insurance.

In another aspect, the data of indicators may include, without limitation, data relating to the dispensing of controlled substance, the number of prescriptions, multiple prescriptions to a single patient, multiple classes of controlled substance to a single patient, percent of controlled substance dispensed, exceeding a set threshold in a given time, or the ratio of inventory of controlled substances vs. uncontrolled prescription dispensed.

In another aspect, the data of indicators may include, without limitation, data relating to the ordering of a controlled substance, orders placed to pharmacy warehouses, ratio of orders of controlled vs. uncontrolled substances, ratios when compared to other pharmacies, and change in ratios over time.

In another aspect of the invention, a high abuse or diversion likelihood score, indicating high probability of abuse or diversion, is assigned when the dispenser data and the data of indicators overlap and where the overlap is high. A low abuse or diversion likelihood score, indicating low probability of abuse or diversion, is assigned when the dispenser data and the data of indicators overlap and where the overlap is low.

The overlap and the determination of whether the overlap is high or low can be computed by a summation of weighted matches between the dispenser data and the data of indicators.

In some instances an authorized user of the method may permanently set the abuse or diversion likelihood score high or low as needed.

In a further aspect of the invention, the abuse or diversion likelihood score is used for decision making by prescribers, law enforcement, government agencies, research organizations, regulatory or licensing agencies, insurance agencies, parole boards, or by predictive modeling software.

### Software for Prediction: Abuse or Diversion by a Dispenser

In another embodiment, the invention is a computer readable medium comprising computer executable instructions recorded thereon for performing the method of predicting abuse or diversion of one or more controlled substances. The method involves identifying a dispenser, accessing one or more databases containing dispenser data, comparing dispenser data with data of indicators, and assigning an abuse or diversion likelihood score to the dispenser.

The terms “computer-readable medium” and “computer executable instructions” are as described in the preceding sections. Aspects of the invention relating to controlled substances, databases containing dispenser data, data of indicators, and assignment of abuse or diversion likelihood score are as described in the above sections.

Aspects of the invention relating to controlled substances, databases containing dispenser data, data of indicators, and assignment of abuse or diversion likelihood scores are as described in the above section.

In a further aspect of the invention, the abuse or diversion likelihood score is computed, without limitation, at fixed intervals and before disciplinary board meetings. A plot of the variation of the score with time and inflections also can be presented.

In yet another aspect of the invention, the abuse or diversion likelihood score is displayed, without limitation, in a format of user's choice. For example, the abuse or diversion likelihood score can be in the numerical range: 0-100. The score also may be coded by a color; for example: red is used to indicate high alert, green indicates a very low score, and shades of yellow, amber, and orange may be used for the scores in between.

In yet another aspect of the invention, a display of location information is presented. For example, location information, without limitation, can be presented on a map. In this example, a location on the map is highlighted in a color different from the background color, and the shade of the highlight turns darker with the number of visits. As another example, the size of the highlight turns larger with the number of visits. As yet another example, the highlight may be color coded to indicate the level of abuse or diversion likelihood score contribution (to a specific patient or prescriber and in general) from the location; for example, a location prescribing or dispensing large quantity of opiates is coded with a red highlight.

In another aspect of the invention, a display of the timeline of filled prescriptions is presented. For example, the display can be grouped, without limitation, by the frequency of filled prescriptions or by the type of controlled substance dispensed.

In another aspect of the invention, the timeline of disciplinary actions against the dispenser can be presented, where recent actions are highlighted.

In another aspect of the invention, the above-mentioned display is presented, without limitation, via a pull notification. For example, a doctor clicks on a few web links and determines the patient-requested dispenser's abuse or diversion likelihood score.

In another aspect of the invention, the display is presented, without limitation, via push notification. For example, an authorized person at the state board receives an email, which alerts her to the high abuse or diversion likelihood score of a pharmacy location.

In one embodiment, the software of this invention is integrated with other software, such other software, without limitation, includes a Health Information Exchange (HIE) program, an electronic medical record (EMR) program, or an electronic healthcare record (HER) program.

In another embodiment, the software of this invention is interfaced with other software, which can be achieved via an application programming interface (API).

### EXAMPLE 1

Leslie Johnson, a 49 year-old woman with 2 teenage boys, called into Dr. Winton's office to refill her monthly prescription of oxycodone, which she had been taking for severe osteoarthritis. Noting that Leslie was more than a week early for a refill, Dr. Winton used an embodiment of the present invention to search her records, which, through an appropriately tuned data of indicators, showed a pattern of increasingly early refills over the previous 5 months and hence a high abuse or diversion likelihood score (of 98). In response to Dr. Winton's questions about adherence, Leslie proudly explained that she takes her medicine as prescribed, never deviating from his instructions. Thinking out loud about why her pills had not lasted through the entire month, Leslie revealed that one of her sons had recently been skipping school and socializing with older boys who had been in trouble with the law. When Dr. Winton asked about access to the pills, Leslie answered that she kept all her medicines in an unlocked cabinet in her house's only bathroom. Raising the possibility that Leslie's son or his friends might be diverting the oxycodone pills, Dr. Winton suggested that she keep them in a more secure place, educated her on proper medication storage, and suggested that she have her son evaluated for possible substance abuse or diversion issues. Additionally, Dr. Winton gave the patient a urine drug screen and followed up with urine drug screens every month for the next six months.

Over the next six months, Leslie's abuse or diversion likelihood score decreased, as she no longer required early refills, and her urine screens came back consistently as expected.

### EXAMPLE 2

Jason was admitted to a treatment facility for polypharmacy addiction. He was found to have multiple drugs in his system, including benzodiazepines, cocaine, and opioids. Jason was weaned off the Xanax with clonazepam and opioids with suboxone, respectively.

After 28 days, Jason left treatment and was followed by the rehab's aftercare program, which consisted of monthly urine screens, group and individual therapy, as well as other activities to help minimize risk of relapse. His urine drug screens (further described below) showed his progression as he was weaned off the drugs he abused or diverted, and once stabilized on suboxone and clonazepam, he was tapered off of those medications.

The urine test results from the day of admission as well as all subsequent test results were entered into a database that an embodiment of the present invention accesses. At the end of the year, a rehab doctor, Dr. Watson, uses an embodiment of the present invention, having an appropriately tuned data of indicators, and finds that Jason has a high abuse or diversion likelihood score (of 95), at least because his urine test results show increasing levels of clonazepam metabolites in the recent months. This was not consistent with the prescription provided by the rehab facility or by Dr. Watson. The concerned authorities are alerted of Jason's non-compliance through a feature of the present invention, which can be accomplished through web links or other supported reporting tools.

### EXAMPLE 3

Jamie is a 38 year-old woman with breast cancer, who underwent a bilateral mastectomy 2 years ago along with four cycles of chemotherapy. While she is considered to be without any evidence of disease, Jamie now suffers from post-surgical chronic pain with constant sharp, stabbing pain along the surgical lines. She has been taking gabapentin, which helps decrease the pain somewhat.

Jamie has also been taking hydrocodone/acetaminophen, 10 mg/325 mg, three times per day for the last 2 years. Jamie has made only one early refill request, which she stated was because she was going on vacation for 2 weeks. Jamie signed an opioid contract and had a baseline urine drug test before starting the hydrocodone. Jamie has had random urine tests throughout her treatment, and has never had a positive test.

Jamie is now applying for an office job with the Department of Transportation and must disclose her use of hydrocodone and now requests a note from her pain doctor, Dr. Winton.

Using an embodiment of the present invention, Dr. Winton searches for Jamie and finds a low abuse or diversion likelihood score (25) and a graph of the score showing her consistent accountability and compliance with her opioid contract and her physician. Upon seeing this data, Dr. Winton is able to write the letter of compliance and advocate for Jamie, as her compliance with her treatment plan and her responsible use of opioid pain medication is well documented in her EMR and easy to confirm for use of advocating on her behalf.

It is to be understood that although aspects of the present invention are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular example, methodology, or protocol described herein. As such, various modifications or changes to or alternative configurations of the disclosed subject matter can be made in accordance with the teachings herein without departing from the spirit of the present invention. Lastly, the terminology used herein is for the purpose of describing particular embodiments only, and is not intended to limit the scope of the present invention, which is defined solely by the claims. Accordingly, the present invention is not limited to that precisely as shown and described.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventor intends for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified, thus fulfilling the written description of all Markush groups used in the appended claims.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

All patents, patent publications, patent applications, and other references identified in the present specification are individually and expressly incorporated herein by reference in their entirety for the purpose of describing and disclosing, for example, the compositions and methodologies described in such references that might be used in connection with the present invention. These references are provided solely for their disclosure prior to the filing date of the present application. Nothing in this regard should be construed as an admission that the inventor is not entitled to antedate such disclosure by virtue of prior invention or for any other reason. All statements as to the date or representation as to the contents of these documents is based on the information available to the applicants and does not constitute any admission as to the correctness of the dates or contents of these documents.

What is claimed is:

1. A method of predicting abuse or diversion of one or more controlled substances, comprising:
a) identifying a potential abuser or diverter;
b) accessing one or more databases containing abuser or diverter data;
c) comparing said abuser or diverter data with data of indicators; and
d) assigning an abuse or diversion likelihood score to the potential abuser or diverter.

2. The method of claim 1 wherein the potential abuser or diverter is a patient.

3. The method of claim 1 wherein the potential abuser or diverter is a prescriber.

4. The method of claim 1 wherein the potential abuser or diverter is a dispenser.

5. The method of claim 1 wherein the step of assigning an abuse or diversion likelihood score includes the step of performing a summation of weighted matches between the abuse or diverter data and the data of indicators.

6. A computer readable medium comprising computer executable instructions recorded thereon for performing a method of predicting abuse or diversion of one or more controlled substances, comprising:
a) identifying a potential abuser or diverter;
b) accessing one or more databases containing abuser or diverter data;
c) comparing said abuser or diverter data with data of indicators; and
d) assigning an abuse or diversion likelihood score to the potential abuser or diverter.

7. The computer readable medium of claim 6 wherein the potential abuser or diverter is a patient.

8. The computer readable medium of claim 6 wherein the potential abuser or diverter is a prescriber.

9. The computer readable medium of claim 6 wherein the potential abuser or diverter is a dispenser.

10. The computer readable medium of claim 6 wherein the step of assigning an abuse or diversion likelihood score includes the step of performing a summation of weighted matches between the abuse or diverter data and the data of indicators.

11. An apparatus for predicting abuse or diversion of one or more controlled substances, comprising:
a) an input device for identifying a potential abuser or diverter;
b) one or more databases containing abuser or diverter data;
c) a processor for comparing said abuser or diverter data with data of indicators and for assigning an abuse or diversion likelihood score to the potential abuser or diverter.

12. The apparatus of claim 11 wherein the potential abuser or diverter is a patient.

13. The apparatus of claim 11 wherein the potential abuser or diverter is a prescriber.

14. The apparatus of claim 11 wherein the potential abuser or diverter is a dispenser.

15. The apparatus of claim 11 wherein the processor assigns an abuse or diversion likelihood score based in part on performing a summation of weighted matches between the abuse or diverter data and the data of indicators.
